(19) United States
(12) Patent Application Publication
(10) Pub. No.: US 2014/0089562 A1
(43) Pub. Date: Mar. 27, 2014

(54) EFFICIENT I/O PROCESSING IN STORAGE SYSTEM

(71) Applicants: Akira DEGUCHI, Sunnyvale, CA (US); Akio NAKAJIMA, Sunnyvale, CA (US)

(72) Inventors: Akira DEGUCHI, Sunnyvale, CA (US); Akio NAKAJIMA, Sunnyvale, CA (US)

(73) Assignee: HITACHI, LTD., Tokyo (JP)

(21) Appl. No.: 13/628,333

(22) Filed: Sep. 27, 2012

(51) Int. Cl. G06F 12/02; G06F 12/16

(52) U.S. Cl. 711/103; 711/154; 711/162; 711/E12.008; 711/E12.103

(57) ABSTRACT

Exemplary embodiments provide information processing system and data processing for efficient I/O processing in the storage system. In one aspect, a storage system comprises: a memory; and a controller being operable to execute a process for data stored in the memory so that an address of the data stored in the memory is changed between a first address managed in a virtual memory on a server and a second address managed by the controller, based on a command containing an address corresponding to the first address, the command being sent from the server to the storage system. In some embodiments, the memory includes a server data memory and a storage data memory. In specific embodiments, in response to the command from the server, the controller is operable to change a status of data stored in the memory from server data to storage data or from storage data to server data.

### BACKGROUND OF THE INVENTION

The present invention relates generally to information processing system and data processing and, more particularly, to efficient input/output (I/O) processing in storage system.

In this decade, storage system consolidation has been advanced. Storage system consolidation gathers the data stored in one or more servers to the storage system. The consolidated data is called “storage data” in this disclosure. Temporary calculated data and cache data of the storage data are still stored in the server main memory. The reason is that the access latency of the storage system is large, among others. The data stored in the server memory is called “server memory data.” Recently, the large access latency is being improved by low latency network such as Infiniband and Flash Memory whose latency is lower than that of HDD (Hard Disk Drive). The technology which constitutes memory cloud with one or more apparatuses having main memory has emerged. See, e.g., RNA Networks Memory Virtualization Solution Using RNA MVX and Mellanox ConnectX-2 EN with RoCE Accelerates Business Analytics by 10 Times.

The prior art does not consider storing the server memory data and the storage data in the same apparatus. As such, the server memory data and the storage data are processed, respectively, according to each protocol of the separate apparatuses. Individual processing is needed even if the server memory data and storage data are stored in the same physical apparatus by chance. This causes the low usage efficiency of the various resources. In addition, the prior art does not consider that the storage system has cache memory. Therefore, it does not disclose the technology to share the memory for server memory data and the cache memory of the storage system. It renders cost reduction difficult. Furthermore, the prior art does not consider configuring the memory for server memory data from Flash Memory or combination of Flash Memory and DRAM. As a result, the data storage involves a very high cost.

### BRIEF SUMMARY OF THE INVENTION

Exemplary embodiments of the invention provide information processing system and data processing for efficient I/O processing in the storage system. This invention is used to improve the usage efficiency of various resources and reduce the cost of the information processing system.

In a first embodiment, the storage I/O processing flows in the configuration in which the storage system has server data memory are described. Furthermore, methods of copying the data from server data memory to storage data memory in the storage system are described. The usage efficiency of various resources is increased. The amount of data transferred is decreased.

In a second embodiment, methods of reducing the number of times of transfer between the server data memory and storage data memory in the storage system are described. The amount of the bandwidth used by data transfer in the storage system is reduced.

In a third embodiment, the server data memory is configured by tier, such as DRAM and Flash Memory. In this configuration, the amount of data transfer or the number of times of write to the Flash Memory is reduced by compressing and/or de-duplicating the data on the memory.

In accordance with an aspect of the present invention, a storage system comprises: a memory; and a controller being operable to execute a process for data stored in the memory so that an address of the data stored in the memory is changed between a first address managed in a virtual memory on a server and a second address managed by the controller, based on a command containing an address corresponding to the first address, the command being sent from the server to the storage system.

In some embodiments, the memory includes a server data memory and a storage data memory, wherein if the command is a write command including an address in the server data memory, the controller is configured to copy data from the address in the server data memory to the storage data memory, and wherein if the command is a read command including an address in the server data memory, the controller is configured to copy data from the storage data memory to the address in the server data memory. The storage system further comprises a first type interface being operable to communicate with the server using a memory access, and a second type interface being operable to communicate with the server using a storage I/O (Input/Output) access. The controller is operable to manage data as either data to be communicated via the first type interface or data to be communicated via the second type interface. The memory includes a server data memory and a storage data memory, and in response to a write command containing a specified address from the server, the controller is operable to allocate an area in the storage data memory, and copy write data from the server data memory, at the specified address contained in the write command, to the allocated area of the storage data memory.

In specific embodiments, the memory includes a server data memory and a storage data memory, wherein in response to a read command containing a specified address from the server, the controller is operable to: if read data is stored in the storage data memory, transfer the read data from the storage data memory to the server data memory, at the specified address contained in the read command; and if read data is not stored in the storage data memory, allocate an area in the storage data memory, transfer the read data from a storage device in the storage system to the allocated area in the storage data memory, and transfer the read data from the allocated area in the storage data memory to the server data memory, at the specified address contained in the read command.

In some embodiments, the memory includes a server data memory and a storage data memory, wherein in response to a read command containing a specified address from the server, the controller is operable to: if there is dirty data, allocate an area in the storage data memory, transfer the read data from a storage device in the storage system to the allocated area in the storage data memory to be merged with the dirty data, and transfer the read data from the allocated area in the storage data memory to the server data memory, at the specified address contained in the read command; and if there is no dirty data, transfer the read data from a storage device in the storage system to the server data memory, at the specified address contained in the read command.

In specific embodiments, in response to the command from the server, the controller is operable to change a status of data stored in the memory from server data to storage data or from storage data to server data. The memory includes DRAM and Flash memory, wherein the controller is operable to: configure server data memory logically on the Flash memory for storing server memory data; use the DRAM as a cache media of the Flash memory; and execute destaging of the server memory data stored in the server data memory configured on the Flash memory after at least one of de-duplication or compression of the server memory data. The storage system further comprises an interface being operable to communicate with the server for both memory access processing and storage I/O (Input/Output) processing.

Another aspect of the invention is directed to a computer-readable storage medium storing a plurality of instructions for controlling a data processor to manage data in a storage system having a memory and a controller. The plurality of instructions comprise instructions that cause the data processor to execute a process for data stored in the memory so that an address of the data stored in the memory of the storage system is changed between a first address managed in a virtual memory on a server and a second address managed by the controller, based on a command containing an address corresponding to the first address, the command being sent from the server to the storage system.

In some embodiments, the storage system includes a first type interface being operable to communicate with the server using a memory access and a second type interface being operable to communicate with the server using a storage I/O (Input/Output) access, and the plurality of instructions further comprise instructions that cause the data processor to manage data as either data to be communicated via the first type interface or data to be communicated via the second type interface. The plurality of instructions further comprise, in response to the command from the server, instructions that cause the data processor to change a status of data stored in the memory from server data to storage data or from storage data to server data.

Another aspect of this invention is directed to a method of managing data in a storage system having a memory and a controller. The method comprises executing a process for data stored in the memory so that an address of the data stored in the memory is changed between a first address managed in a virtual memory on a server and a second address managed by the controller, based on a command containing an address corresponding to the first address, the command being sent from the server to the storage system.

These and other features and advantages of the present invention will become apparent to those of ordinary skill in the art in view of the following detailed description of the specific embodiments.

### BRIEF DESCRIPTION OF THE DRAWINGS

FIG. 1 illustrates an example of a configuration of an information processing system in which the method and apparatus of the invention may be applied.

FIG. 2 illustrates an example of the details of storage configuration of the storage system.

FIG. 3 is a conceptual diagram illustrating a system configuration in which the storage system has a server data memory.

FIG. 4 shows an example of a memory map table managed in the server.

FIG. 5 is a detailed block diagram showing the server program unit in accordance with the first embodiment.

FIG. 6 is a detailed block diagram showing the storage program unit in accordance with the first embodiment.

FIG. 7 is a detailed block diagram showing the control information unit in accordance with the first embodiment.

FIG. 8 is a conceptual diagram illustrating a write processing flow of the first embodiment.

FIG. 9 is an example of a flow diagram illustrating a write processing flow of the first embodiment based on a simple method using the conventional write protocol.

FIG. 10 is an example of a flow diagram illustrating a write processing flow of the first embodiment based on a method which reduces the amount of write data transfer.

FIG. 11 is a conceptual diagram illustrating a read processing flow of the first embodiment.

FIG. 12 is an example of a flow diagram illustrating a read processing flow of the first embodiment based on a simple method using the conventional read protocol.

FIG. 13 is an example of a flow diagram illustrating a read processing flow of the first embodiment based on the method which reduces the amount of read data transfer.

FIG. 14 is a conceptual diagram illustrating a method to deal with above situation of a larger access size of server memory data than storage data.

FIG. 15 shows a configuration of a server having a physical memory.

FIG. 16 is a conceptual diagram illustrating shortcut of the transfer of read data.

FIG. 17 is a conceptual diagram illustrating reduction for the number of times of data transfer between the storage data memory and the server data memory for write processing.

FIG. 18 is a conceptual diagram illustrating reduction for the number of times of data transfer between the storage data memory and the server data memory for read processing.

FIG. 19 is a detailed block diagram showing the control information unit in accordance with the second embodiment.

FIG. 20 shows an example of the cache data status table.

FIG. 21 is an example of a flow diagram illustrating a write processing flow according to the second embodiment.

FIG. 22 is an example of a flow diagram illustrating a read processing flow according to the second embodiment.

FIG. 23 is a conceptual diagram illustrating the sharing of physical I/F between the server and storage system by memory access processing and storage I/O processing.

FIG. 24 shows a configuration of a server data memory configured logically on Flash Memories.

FIG. 25 is a conceptual diagram illustrating the destaging of the server memory data after de-duplication and/or compression of them in the storage system.

FIG. 26 is a detailed block diagram showing the control information unit in accordance with the third embodiment.

FIG. 27 shows an example of a server memory data management table.

FIG. 28 is an example of a flow diagram illustrating a processing flow of memory write according to the third embodiment.

FIG. 29 is an example of a flow diagram illustrating a processing flow of a DRAM allocation program called from the memory write program in FIG. 28.

FIG. 30 is an example of a flow diagram illustrating a processing flow of a monitor program executing de-duplication and/or compression according to the amount of free space of DRAM.

FIG. 31 is an example of a flow diagram illustrating a processing flow of a memory read program in order to cache the data from Flash Memory to DRAM according to the third embodiment.

### DETAILED DESCRIPTION OF THE INVENTION

In the following detailed description of the invention, reference is made to the accompanying drawings which form a part of the disclosure, and in which are shown by way of illustration, and not of limitation, exemplary embodiments by which the invention may be practiced. In the drawings, like numerals describe substantially similar components throughout the several views. Further, it should be noted that while the detailed description provides various exemplary embodiments, as described below and as illustrated in the drawings, the present invention is not limited to the embodiments described and illustrated herein, but can extend to other embodiments, as would be known or as would become known to those skilled in the art. Reference in the specification to “one embodiment,” “this embodiment,” or “these embodiments” means that a particular feature, structure, or characteristic described in connection with the embodiment is included in at least one embodiment of the invention, and the appearances of these phrases in various places in the specification are not necessarily all referring to the same embodiment. Additionally, in the following detailed description, numerous specific details are set forth in order to provide a thorough understanding of the present invention. However, it will be apparent to one of ordinary skill in the art that these specific details may not all be needed to practice the present invention. In other circumstances, well-known structures, materials, circuits, processes and interfaces have not been described in detail, and/or may be illustrated in block diagram form, so as to not unnecessarily obscure the present invention.

Furthermore, some portions of the detailed description that follow are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the present invention, the steps carried out require physical manipulations of tangible quantities for achieving a tangible result. Usually, though not necessarily, these quantities take the form of electrical or magnetic signals or instructions capable of being stored, transferred, combined, compared, and otherwise manipulated. It has proven convenient at times, principally for reasons of common usage, to refer to these signals as bits, values, elements, symbols, characters, terms, numbers, instructions, or the like. It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

The present invention also relates to an apparatus for performing the operations herein. This apparatus may be specially constructed for the required purposes, or it may include one or more general-purpose computers selectively activated or reconfigured by one or more computer programs. Such computer programs may be stored in a computer-readable storage medium including non-transient medium, such as, but not limited to optical disks, magnetic disks, read-only memories, random access memories, solid state devices and drives, or any other types of media suitable for storing electronic information. The algorithms and displays presented herein are not inherently related to any particular computer or other apparatus. Various general-purpose systems may be used with programs and modules in accordance with the teachings herein, or it may prove convenient to construct a more specialized apparatus to perform desired method steps. In addition, the present invention is not described with reference to any particular programming language. It will be appreciated that a variety of programming languages may be used to implement the teachings of the invention as described herein. The instructions of the programming language(s) may be executed by one or more processing devices, e.g., central processing units (CPUs), processors, or controllers.

Exemplary embodiments of the invention, as will be described in greater detail below, provide apparatuses, methods and computer programs for efficient I/O processing in storage system.

### First Embodiment

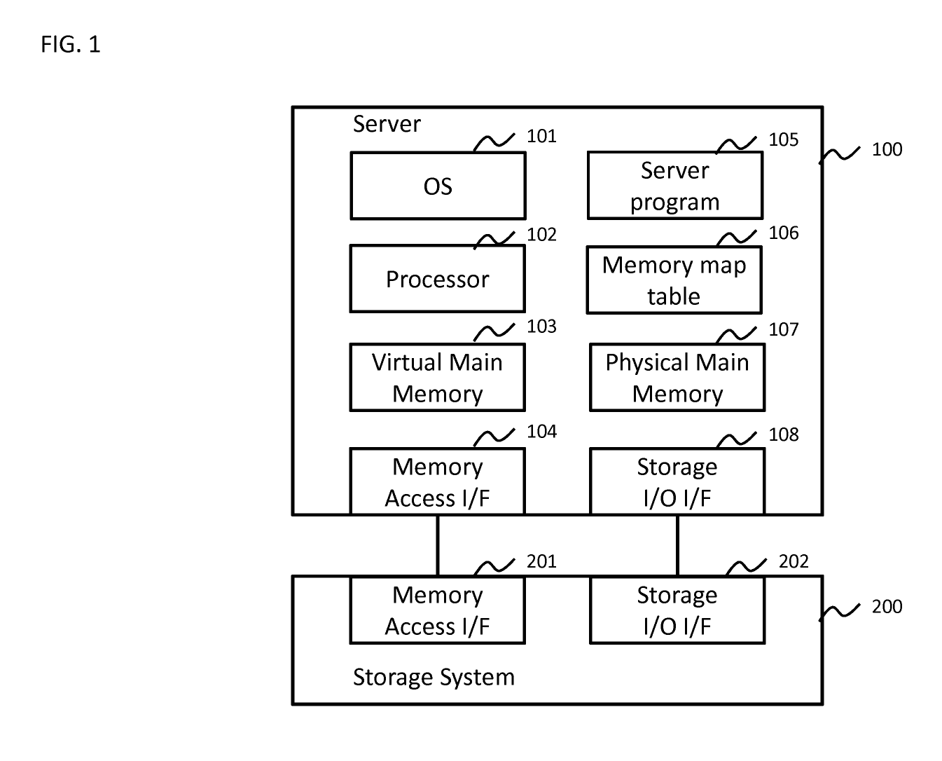

FIG. 1 illustrates an example of a configuration of an information processing system in which the method and apparatus of the invention may be applied. The system includes a server 100 and a storage system 200. The server 100 includes an operating system (OS) 101, a processor 102, a virtual main memory 103, a memory access interface (I/F) 104, a server program unit 105, a memory map table 106, a physical main memory 107, and a storage I/O I/F 108. The storage system 200 includes a memory access I/F 201 and a storage I/O I/F 202. The virtual main memory 103, memory map table 106, and memory access I/F 104 are novel features in the server 100. The memory access I/F 104 is used in order to access the storage system 300 as the server main memory device. Protocols, such as RDMA (Remote Direct Access Memory), are used. The storage I/O I/F 202 is used in order to accesses the storage system 200 as storage device. Protocols, such as Fibre Channel or iSCSI, are used. The server 100 can have application software or database software, and the like.

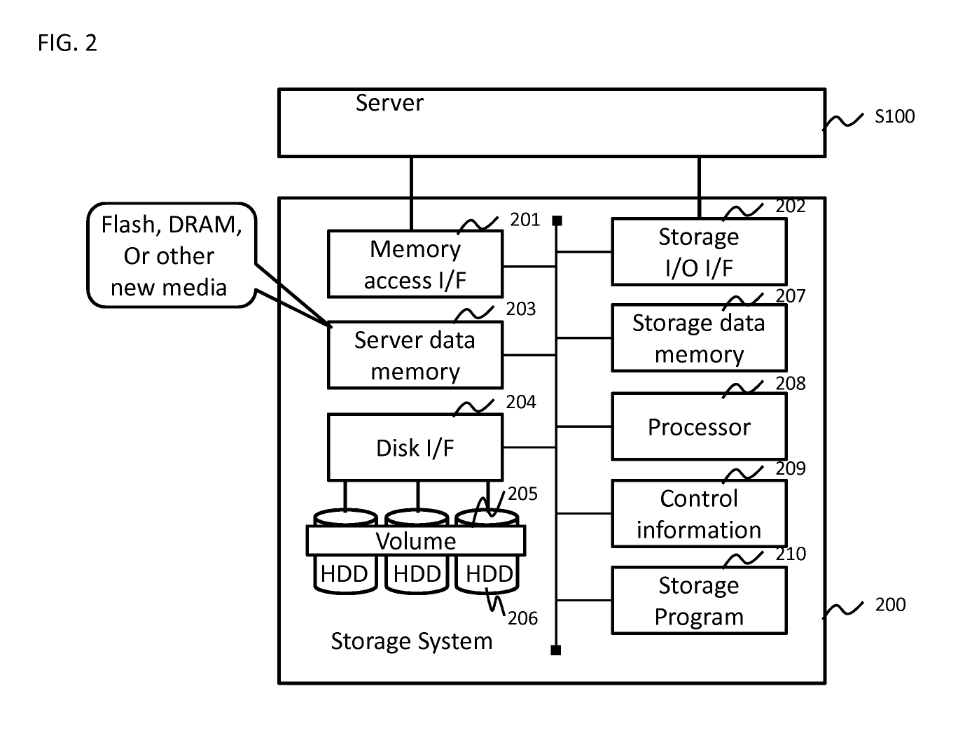

FIG. 2 illustrates an example of the details of storage configuration of the storage system 200. The memory access I/F 201, as a novel component, is connected to the memory access I/F 104 of the server 100 and receives server memory access command from the server 100. The storage I/O I/F is connected to the storage I/O I/F 108 of the server 100 and receives storage access command from the server 100. The storage system 200 further includes a server data memory 203, a disk I/F 204, a volume 205, HDDs 206, a storage data memory 207, a processor 208, control information unit 209, and storage program unit 210.

The server data memory 203, as a novel component, stores the server memory data, such as cached data or temporary calculation result, etc. The storage data memory 207 stores the cache of the data stored in HDD. The control information unit 209 contains information used to execute various storage processing. For example, the control information 209 includes information of volume configuration or storage status, etc. The storage program unit 210 includes various programs, such as read program in order to process read request from the server and write program, etc.

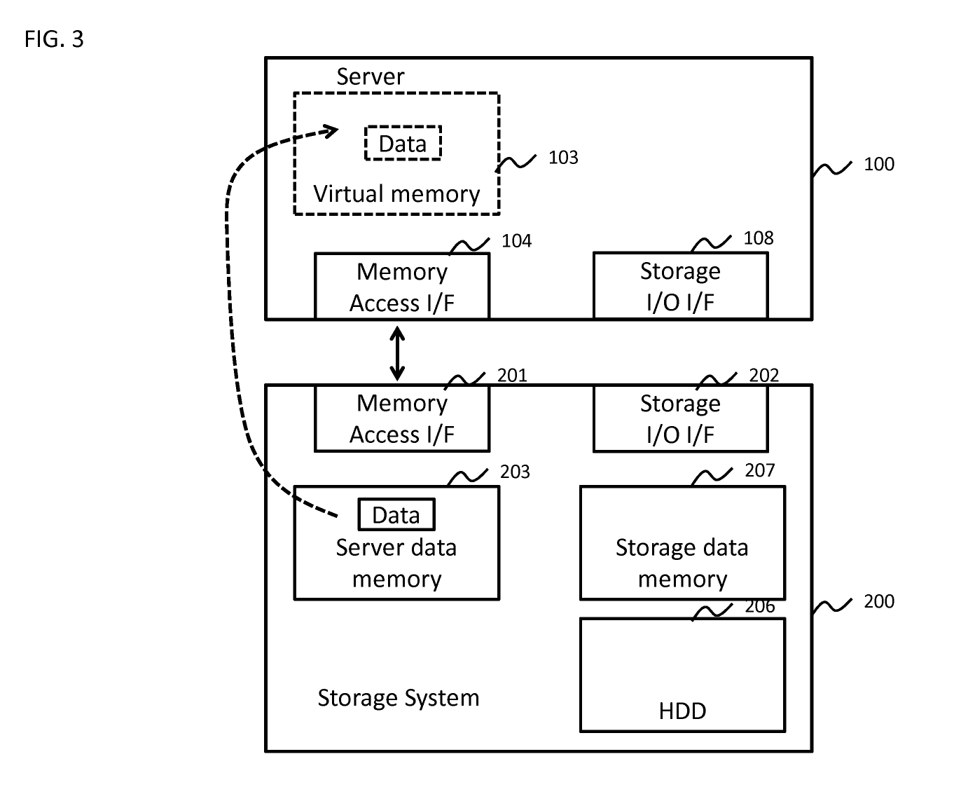

FIG. 3 is a conceptual diagram illustrating a system configuration in which the storage system has a server data memory. Server memory data are stored in the server data memory 203 in the storage system 200 physically. The server 100 has the virtual memory 103 corresponding to the server data memory 203 in the storage system 200 for storing the server memory data. The correspondence relationship is managed by the memory map table 106.

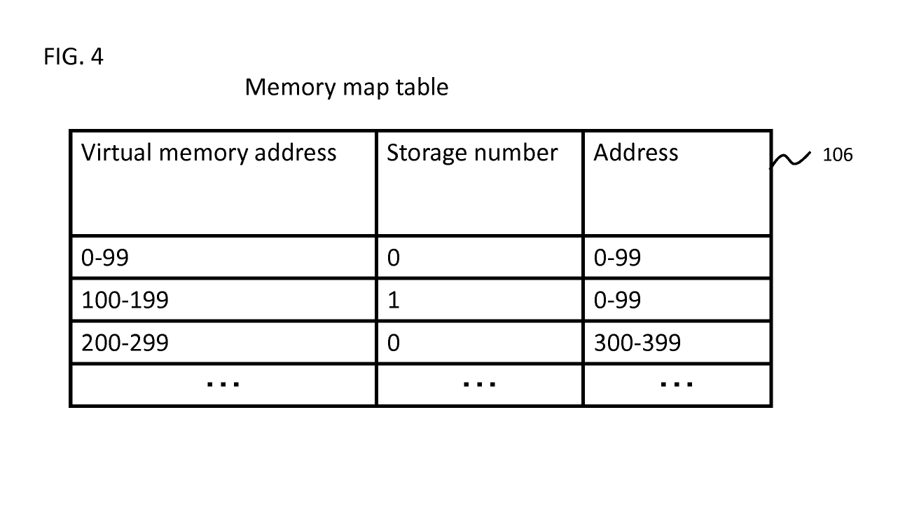

FIG. 4 shows an example of a memory map table managed in the server 100. The memory map table 106 includes columns of virtual memory address, storage number, and address. Virtual memory address is an address of memory space in the server. Storage number and address are the information used to specify the memory address and storage which stores the server memory data physically. The first row means that the data stored to the address of 0-99 in the server memory space is physically stored to the address of 0-99 in the storage system with number 0. The second row means that the data stored to the address of 100-199 in the server memory space is physically stored to the address of 0-99 in the storage system with number 1.

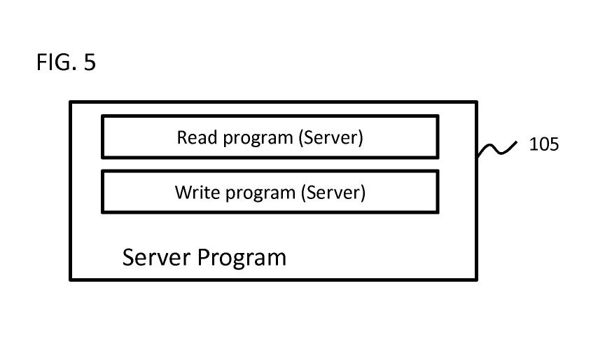

FIG. 5 is a detailed block diagram showing the server program unit 105 in accordance with the first embodiment. Read program (server) is a program to issue a read request to the storage system. Write program (server) is a program to issue a read request to the storage system.

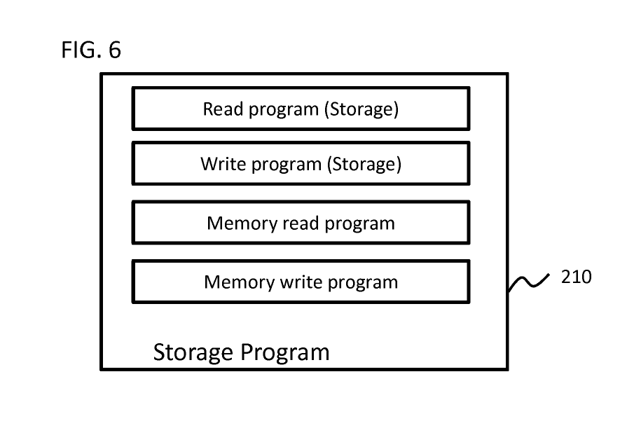

FIG. 6 is a detailed block diagram showing the storage program 210 unit in accordance with the first embodiment. Read program (storage) is a program to receive a read request as storage device from the server and transfer the object read data to the server. Write program (storage) is a program to receive a write request as storage device and object write data from the server and store them in the storage data memory 207. Eventually, the write data is stored in HDD 206. Memory read program is a program to receive a read request as server memory device from the server and transfer the object server memory data from the server data memory 203 to the server. Memory write program is a program to receive a write request as server memory device and object write server memory data from the server and store them in the server data memory 203.

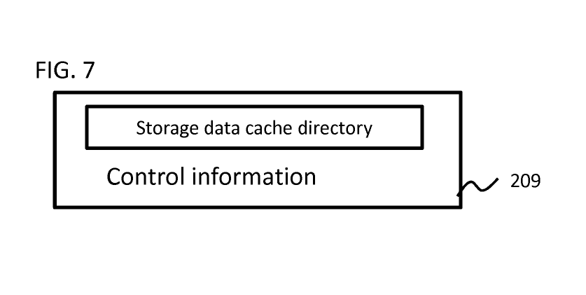

FIG. 7 is a detailed block diagram showing the control information unit 209 in accordance with the first embodiment. A storage data cache directory manages whether the data of a specified address is cache. If the data is cached, the address on storage data memory 207 is also managed.

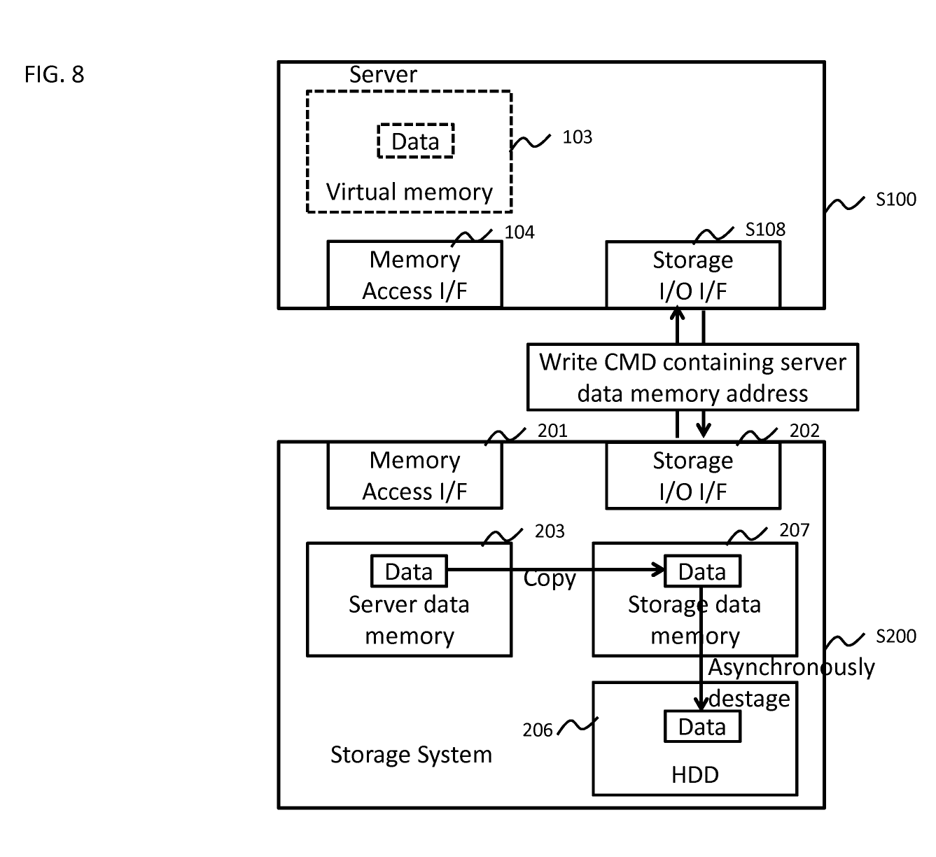

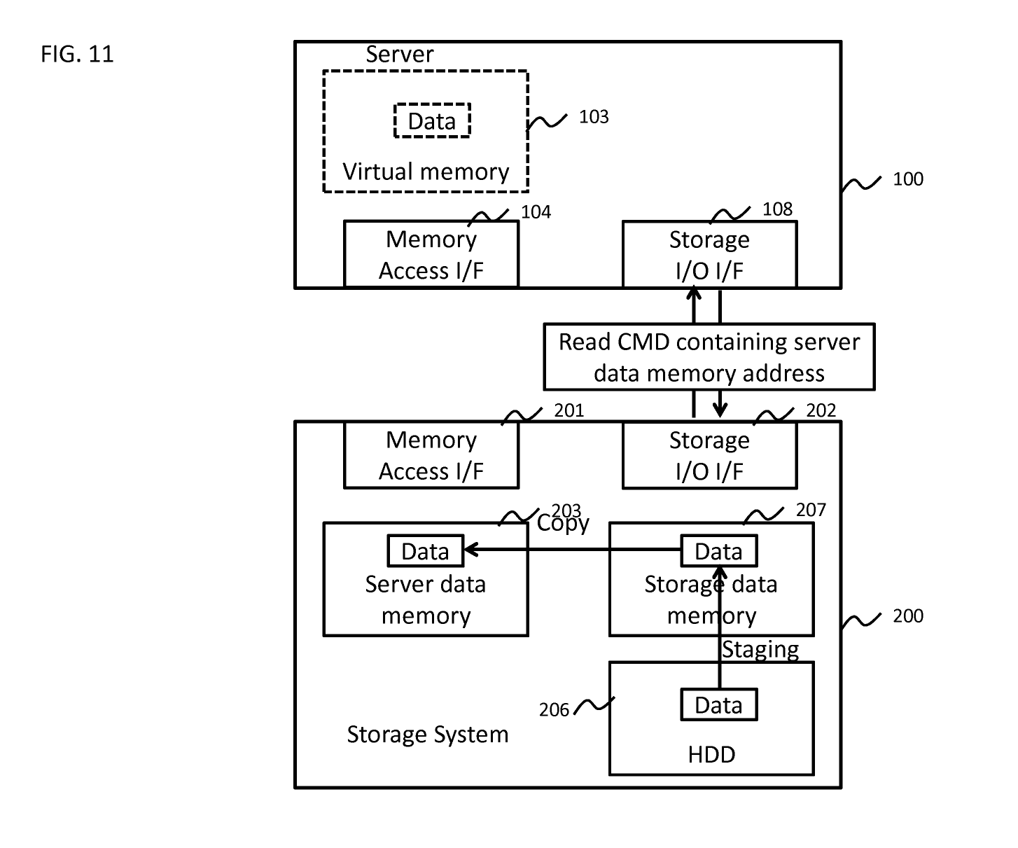

Write processing flow of the first embodiment is described by using FIGS. 8 to 10. Read processing flow of the first embodiment is described by using FIGS. 11 to 13.

FIG. 8 is a conceptual diagram illustrating a write processing flow of the first embodiment. Object write data is copied from the server data memory 203 to the storage data memory 207 in the storage system 200. The write command does not contain write data. The write command contains server data memory address. With the simple method using the conventional write protocol, object write data is read through the memory access I/F 104, 201 and is once again written through the storage I/O I/F 108, 202.

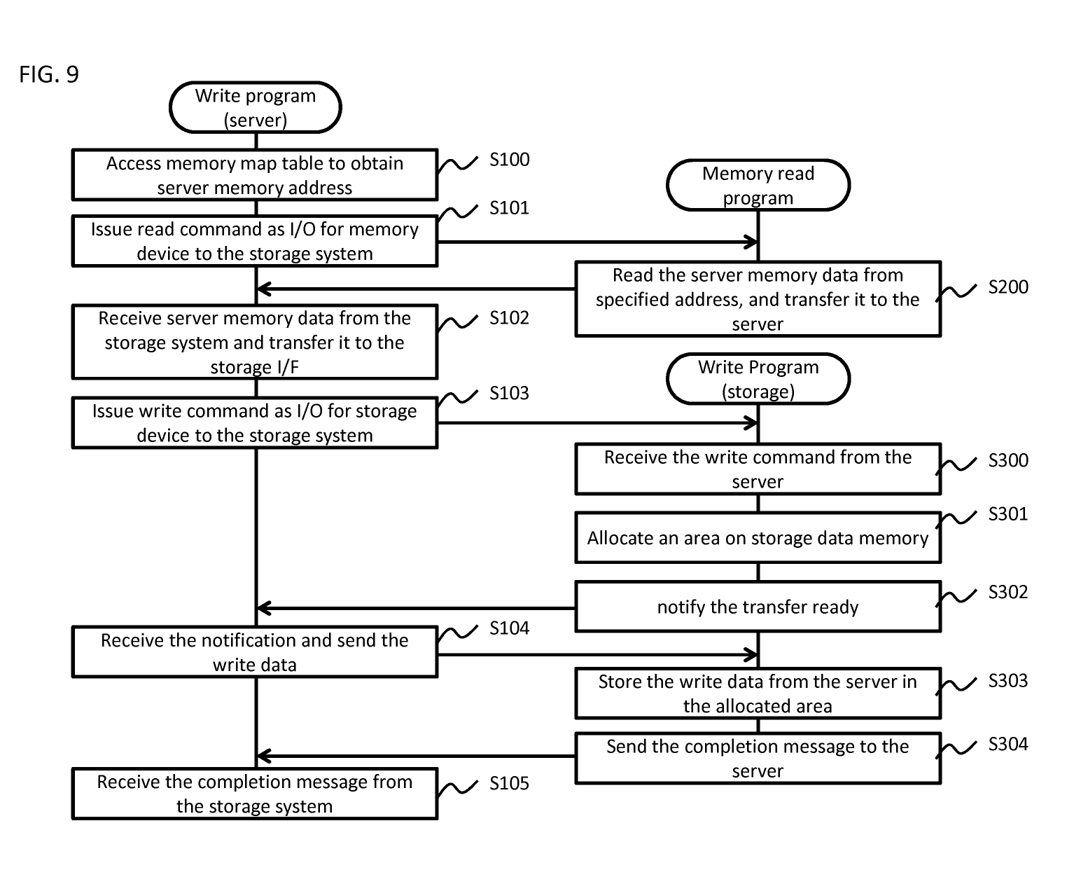

FIG. 9 is an example of a flow diagram illustrating a write processing flow of the first embodiment based on a simple method using the conventional write protocol. The write processing is achieved by the write program (server), memory read program, and write program (storage).

In step S100, the write program (server) accesses the memory map table 106 to obtain the server memory address in which write data is stored. In step S101, the write program (server) issues a read command as I/O for memory device to the storage system 200 to obtain the write data. In step S200, the memory read program which received the read command reads the server memory data from the specified address and transfers it to the server 100. In step S102, the write program (server) which received the server memory data transfers it to the storage I/O I/F 108, 202. In step S103, the write program (server) issues a write command as I/O for storage device to the storage system. This command contains write LBA (Logical Block Address) of the volume 205. The write program (storage) receives the write command from the server (step S300) and allocates an area on the storage data memory 203 (step S301). If the data of the specified LBA is already cached onto storage data memory 203, an area which the data is stored is used for storing the write data. In other words, a new area is not needed. After allocation of the storage data memory 203, the write program (storage) notifies that the transfer is ready (step S302). In step S104, the write program (server) receives the notification and sends the write data to the storage system. In step S303, the write program (storage) receives the write data and stores it in the allocated storage data memory 203. Finally, the write program (storage) sends a completion message to the server (step S304). The write program (sever) receives the completion message and the write process is finished (step S105). As mentioned above, the simple method based write processing flow needs much data transfer and communication between the server 100 and the storage system 200. For this reason, the usage efficiency of various resources is decreased.

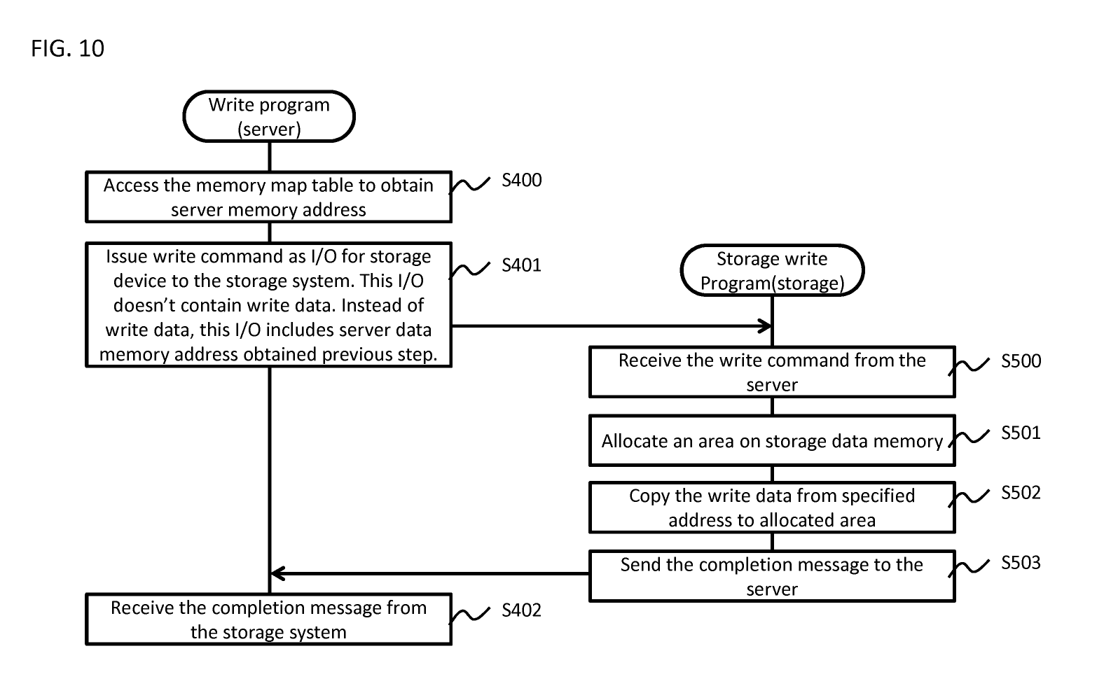

FIG. 10 is an example of a flow diagram illustrating a write processing flow of the first embodiment based on a method which reduces the amount of write data transfer. In step S400, the write program (server) accesses the memory map table 106 to obtain the server memory address in which the write data is stored. This step is the same as step S100 of the simple method based write processing in FIG. 9. In step S401, the write program (server) issues a write command as I/O for storage device to the storage system 200. This command does not contain write data. Instead of write data, this command contains server data memory address obtained in step S400 and write LBA of the volume 205. The write program (storage) receives the write command from the server 100 (step S500) and allocates an area on the storage data memory 207 (step S501). In step S502, the write program (storage) copies the write data from the specified address of the server data memory 203 to the allocated storage data memory 207. Finally, the write program (storage) sends a completion message to the server (step S503). The write program (sever) receives the completion message and the write process is finished (step S402). Steps S503 and S402 are the same as steps S304 and S105 of FIG. 9. As mentioned above, the transfer of write data between the server 100 and the storage system 200 is not needed in the write processing flow of FIG. 10. Communication between the server and the storage system is needed only once.

FIG. 11 is a conceptual diagram illustrating a read processing flow of the first embodiment. Object read data is copied from the storage data memory 207 to the server data memory 203 in the storage system 200. The read command does not contain read data. The read command contains the server data memory address. With a simple method using the conventional read protocol, the object read data is read through the storage I/O I/F 108, 202 and is once again written through the memory access I/F 104, 201.

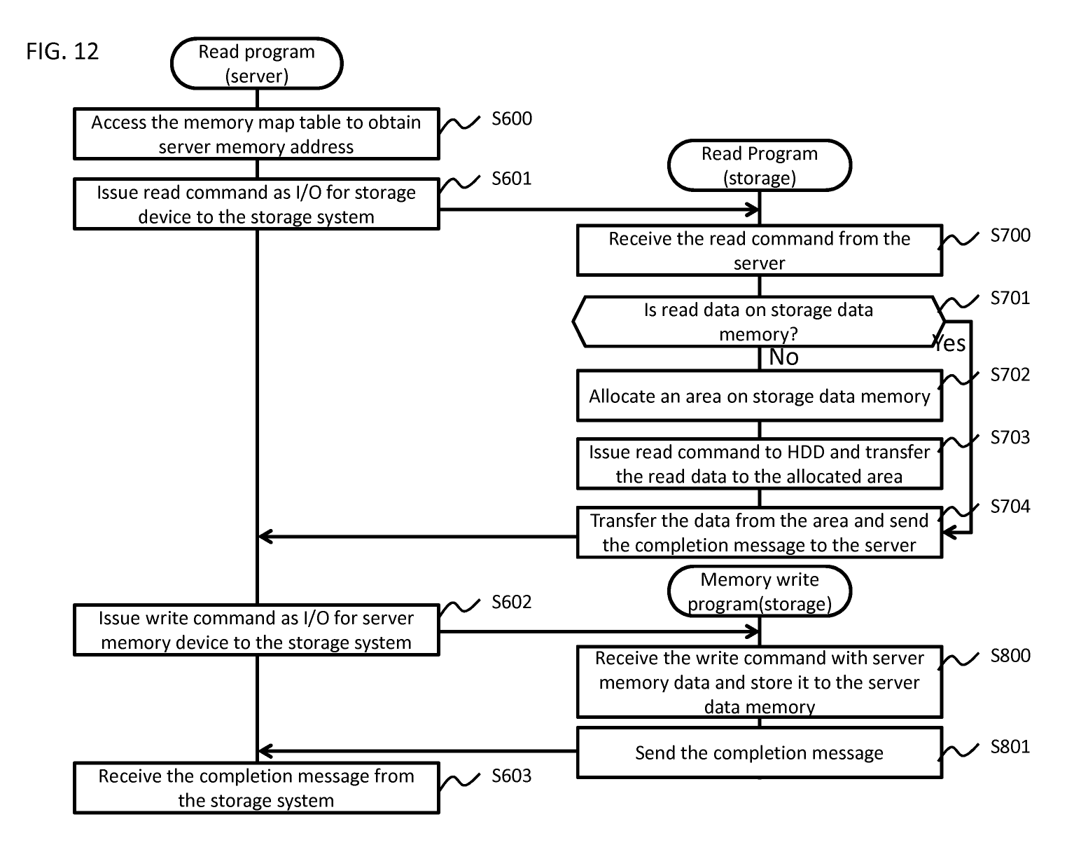

FIG. 12 is an example of a flow diagram illustrating a read processing flow of the first embodiment based on a simple method using the conventional read protocol. The read processing is achieved by the read program (server), read program (storage), and memory write program.

In step S600, the read program (server) accesses the memory map table 106 to obtain the server data memory address for storing read data. In step S601, the read program (server) issues a read command as I/O for storage device to the storage system 200. The read program (storage) which received the read command (step S700) confirms whether object read data is already cached (step S701). If the object read data is cached, the read program (storage) proceeds to step S704. If the object read data is not cached, the read program (storage) allocates an area on the storage data memory 207 (step S702) and issues a read command to the HDD 206 for transfer read data from the HDD to the storage data memory 207 (step S703). After transfer of the read data from the HDD to the storage data memory, the next step is step S704. In step S704, the read program (storage) transfers the read data from the storage data memory 207 to the server 100 and sends a completion message to the server. The read program (server) which received the read data issues a write command as I/O for server memory device to the storage system in order to store the read data as the server memory data (step S602). The write command contains the server memory address obtained in step S600. The memory write program receives the write command with the server memory data and transfers it to the specified address on the server data memory 203 (step S800). The memory write program sends a completion message to the server (step S801). Finally, the read program (server) receives the completion message and the read process is finished (step S603).

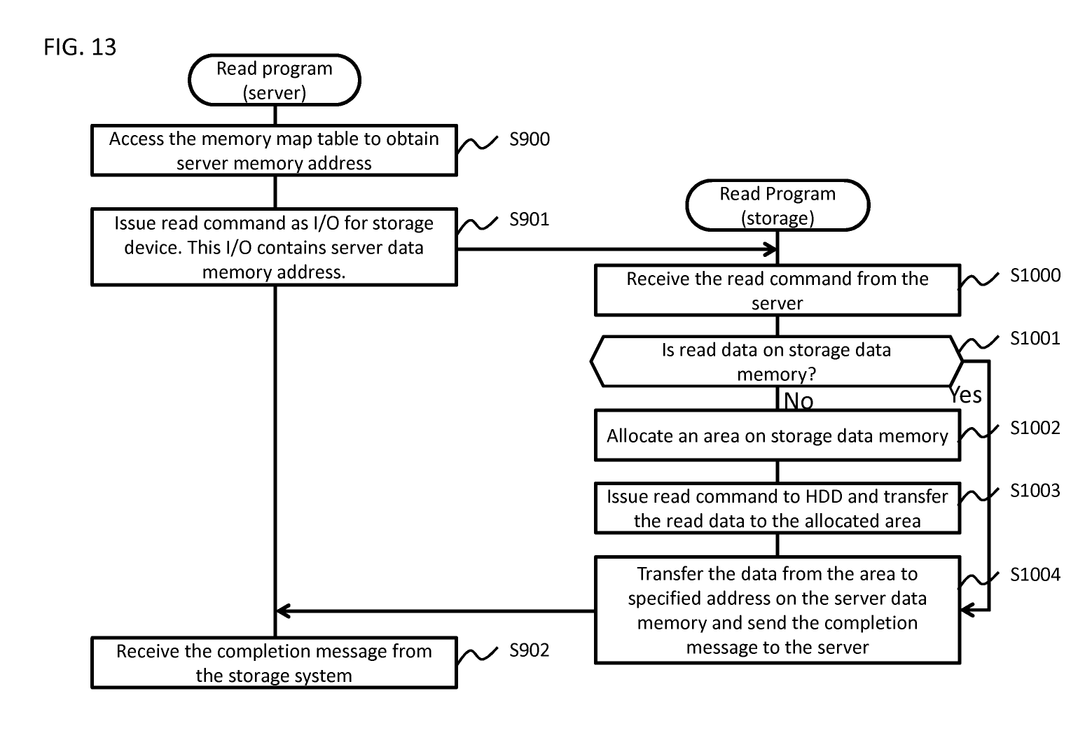

FIG. 13 is an example of a flow diagram illustrating a read processing flow of the first embodiment based on the method which reduces the amount of read data transfer. In step S900, the read program (server) accesses the memory map table 106 to obtain the server data memory address for storing read data. This step is the same as step S600 of the simple method based read processing in FIG. 12. In step S901, the read program (server) issues a read command as I/O for storage device to the storage system. This command contains the server data memory address. The read program (storage) stores the object read data in the storage data memory 207 (steps S1000 to S1003). These steps are the same as steps S700 to S703. In step S1004, the read program (storage) transfers the object read data from the storage data memory 207 to the specified address on the server data memory 203 and sends a completion message to the server. Finally, the read program (server) receives the completion message and the read process is finished (step S902).

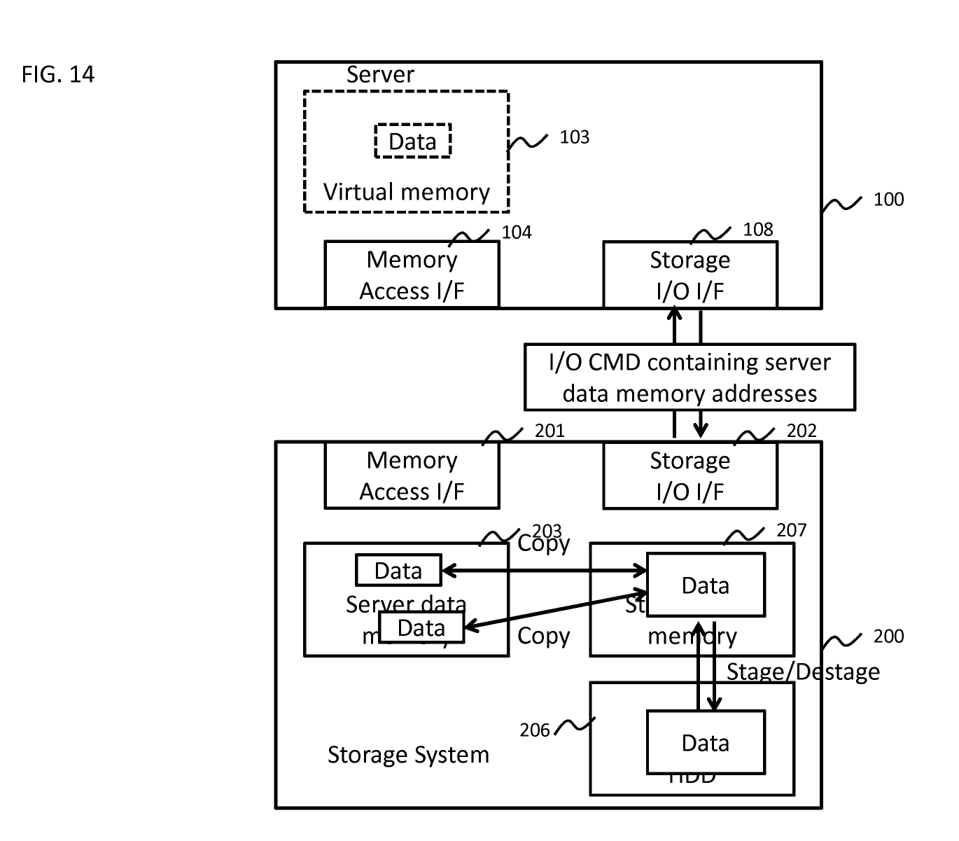

In general, the access size of server memory data is different from the access size of storage data. The access size of server memory data is typically smaller than the access size of storage data. As such, the write data for storage device could be stored in several areas of the server data memory 203. FIG. 14 is a conceptual diagram illustrating a method to deal with above situation of a larger access size of server memory data than storage data. It involves copying between the server data memory 203 and the storage data memory 207 and staging/destaging between the storage data memory and the HDDs 206. An I/O command contains one or more server data memory addresses corresponding to each data.

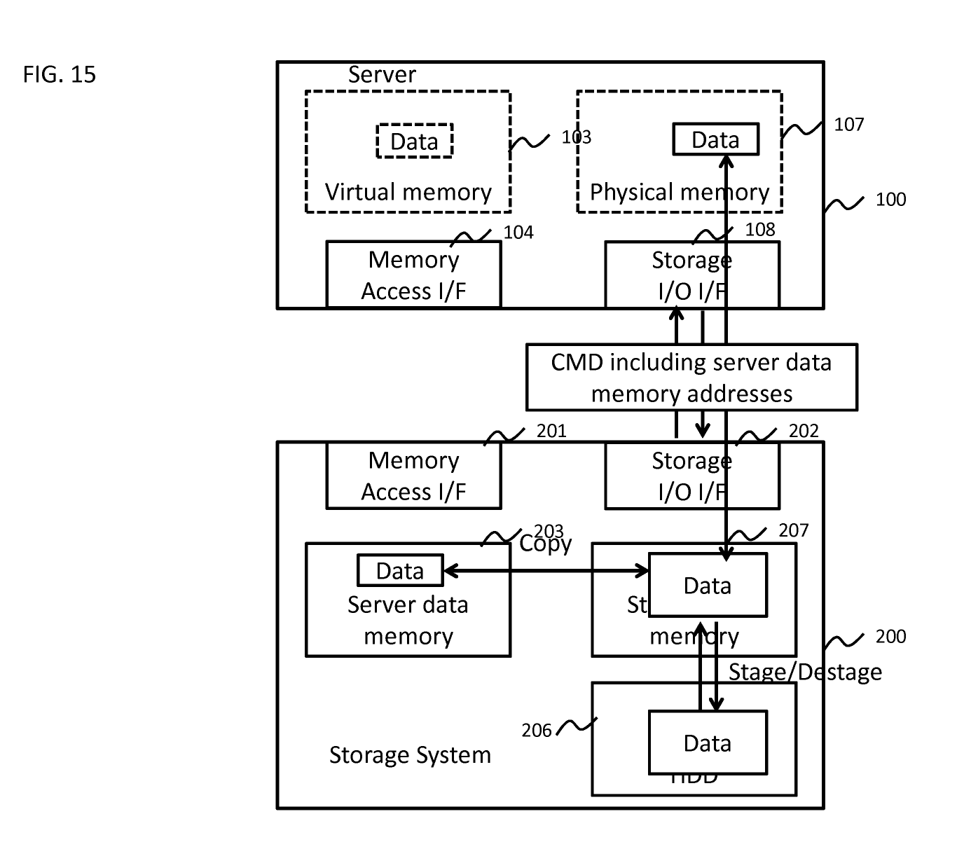

The server may also have a physical memory. FIG. 15 shows a configuration of a server 100 having a physical memory 107. In this configuration, some server memory data could be stored in the physical memory 107 in the server 100 and some other server memory data could be stored in the server data memory 203 in the storage system 200. In other words, data of one read or write command is stored separately. A read or write command contains read data or write data stored in the physical memory 107 in the server 100. The read data or write data is transferred through the storage I/O I/F 108, 202. The read or write command also contains addresses of the data stored in server data memory 203 in the storage system 200.

### Second Embodiment

With the read processing flow of the first embodiment, the read data is transferred from the HDD 206 to the storage data memory 207. Then, the read data is transferred from the storage data memory 207 to the server data memory 203 again. In some cases, however, the read data could be transferred from the HDD 206 to the server data memory 207 directly. In other words, transfer to the storage data memory 207 could be shortcut or bypassed.

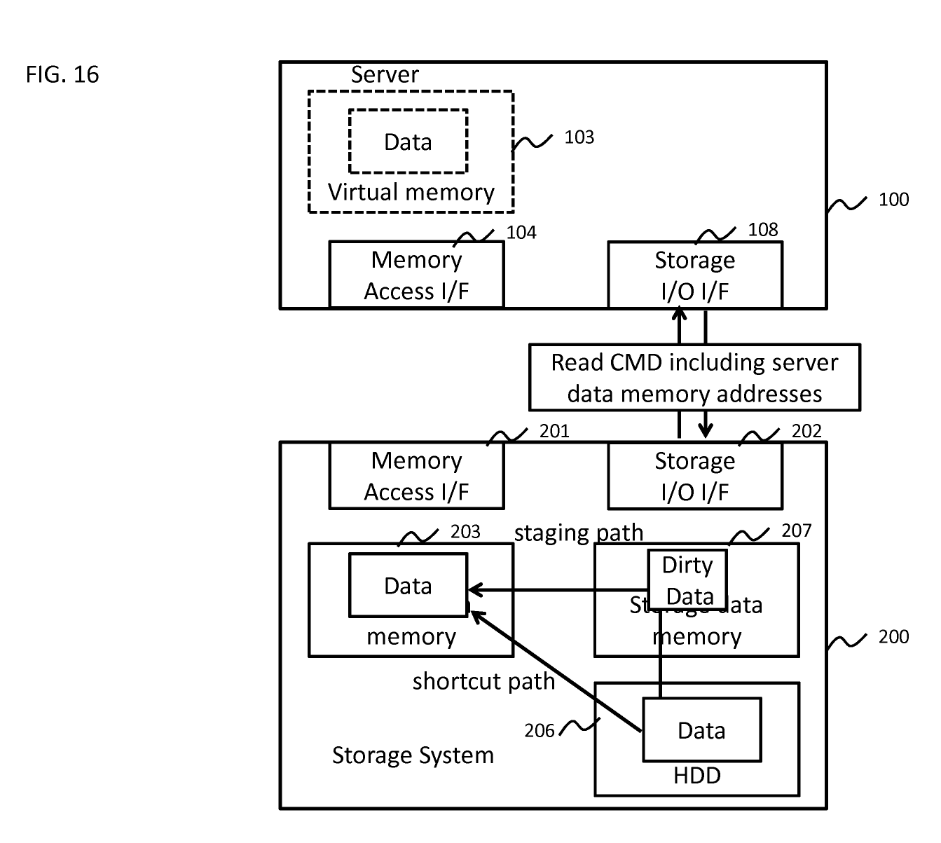

FIG. 16 is a conceptual diagram illustrating shortcut of the transfer of read data. If there is dirty data on the storage data memory 207, the read data should be transferred from the HDD 206 to the storage data memory 207 and merged with the dirty data for consistency. After that, the read data is transferred from the storage data memory 207 to the server data memory 203. For shortcut of write data, the write data must be written in the HDD 206 synchronizing with the write command, because the server 100 may reuse the area (in the virtual memory space) where the write data is stored for other usage after completion of the write command. This shortcut (from the HDD 206 to the server data memory 203) may be used for read data if there is no dirty data.

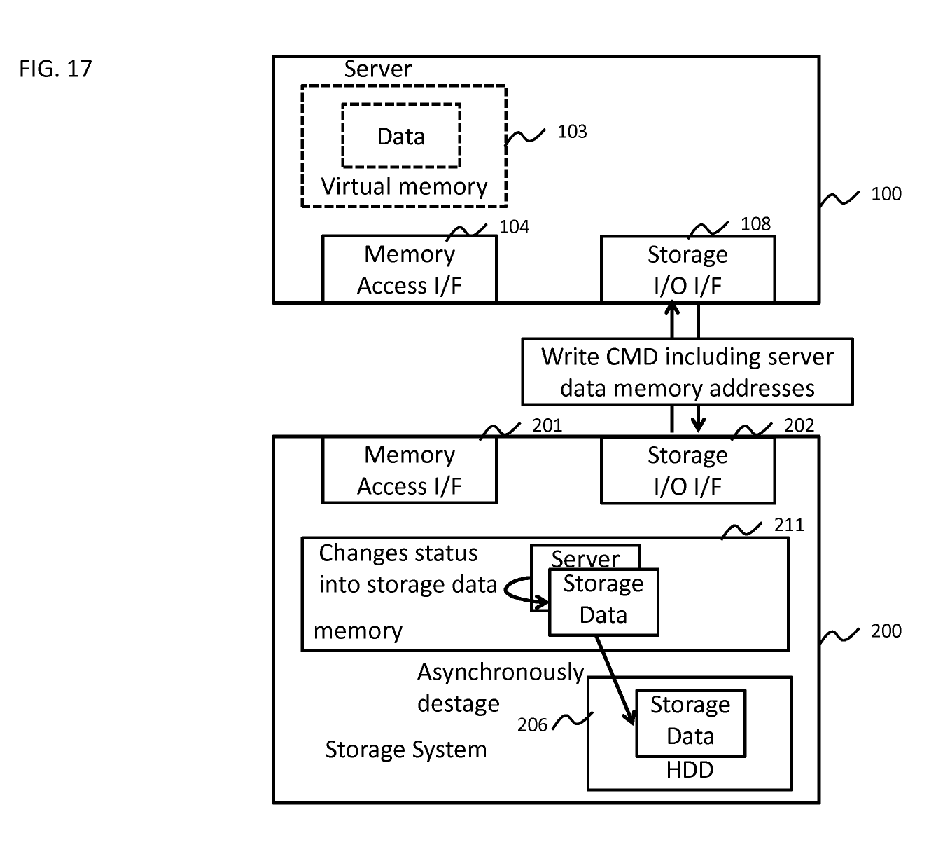

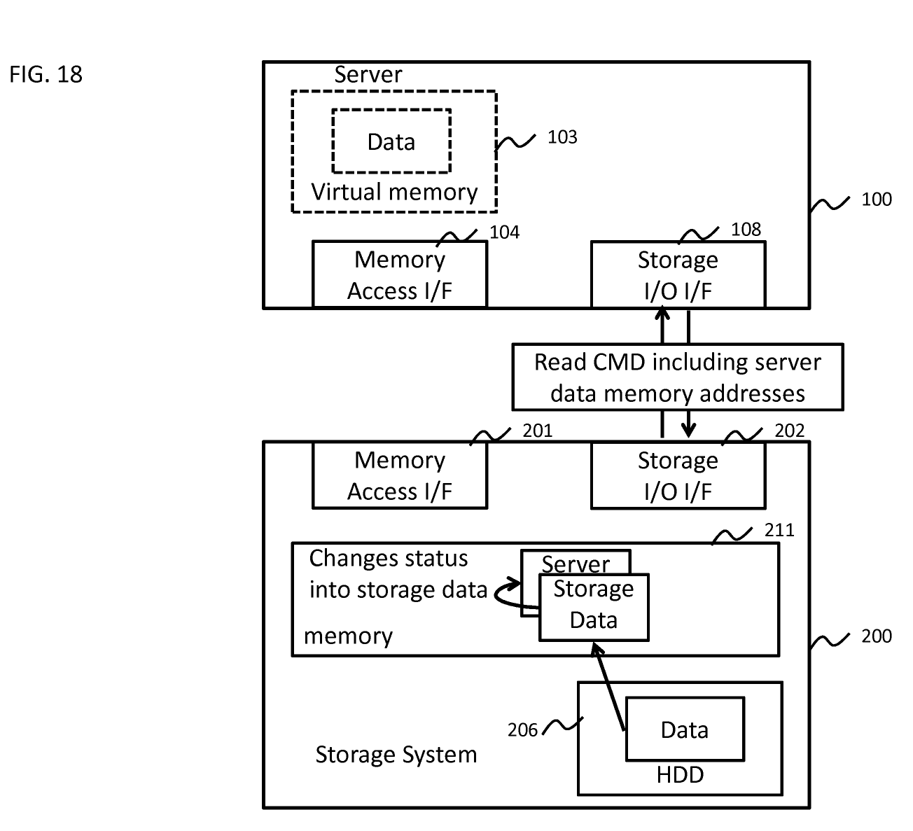

FIG. 17 is a conceptual diagram illustrating reduction for the number of times of data transfer between the storage data memory and the server data memory for write processing. FIG. 18 is a conceptual diagram illustrating reduction for the number of times of data transfer between the storage data memory and the server data memory for read processing. In this configuration, the storage data memory and server data memory are merged. In these figures, the integrated memory is simply called “memory.” For the data on the memory, the storage system manages whether the data is the server memory data or storage memory data. The number of times of transfer is reduced by changing the status of the data in the memory. For example, transfer from server data memory to storage data memory could be achieved by changing the status of the data from server data in the memory to storage data in the memory.

Referring to the writing processing in FIG. 17, write data is stored in the memory 211 as server data. Then, the storage system 200 receives the write command containing the address of the memory storing the object write data. Finally, the storage system 200 changes the status of the data stored in the specified address into storage data.

Referring to the read processing in FIG. 18, the storage system 200 receives the read command containing the address of the memory 211. Then, the storage system 200 transfers the data from the HDD 206 to the specified address of the memory 211 as storage data and changes the status of the data into server memory data. Alternatively, the storage system 200 can transfer the data from the HDD 206 to the memory 211 as server memory data. If the object read data is on the memory 211 as clean cache data, the storage system 200 can delete the clean cache data from the memory 211 and transfer the object read data from the HDD 206 to the specified address. If the object read data is on the memory 211 as dirty cache data, the storage system 200 should copy the dirty data from the memory 211 to the specified address.

A read command without the address of the memory 211 could be considered. The storage system 200 may allocate an area on the memory 211 and transfer the object read data to the allocated area. The storage system 200 then notifies the address of the allocated area with a completion message to the server 100. The server 100 updates the physical address of the memory map table 106 based on the notified address. In this case, there is no need to include the address of the memory 211 in the read command. With the above case, if the object read data is on the memory 211 as clean cache data, the storage system 200 can notify the address of the clean cache data to the server 100. Therefore, transfer from the HDD 206 to the memory 211 is not needed.

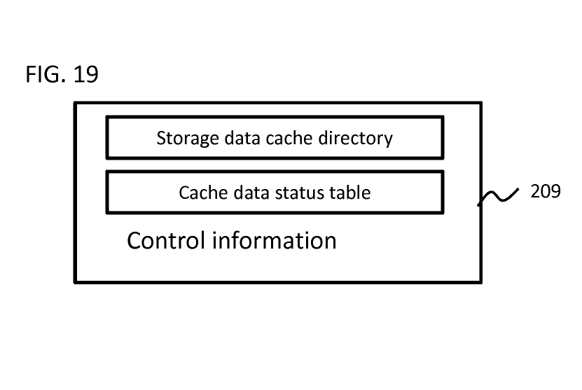

FIG. 19 is a detailed block diagram showing the control information unit 209 in accordance with the second embodiment. The storage data cache directory is the same as that of the first embodiment (FIG. 7). The cache data status table manages the status of the data on the memory 211.

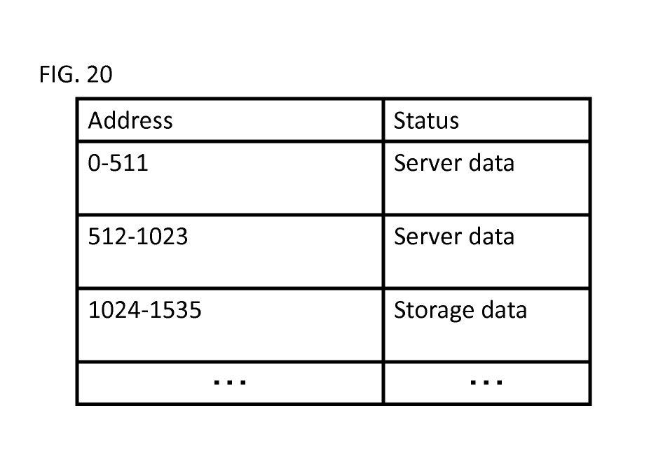

FIG. 20 shows an example of the cache data status table. “Address” means address on the memory 211. “Status” manages the status of the data corresponding to address, which is server memory data or storage data.

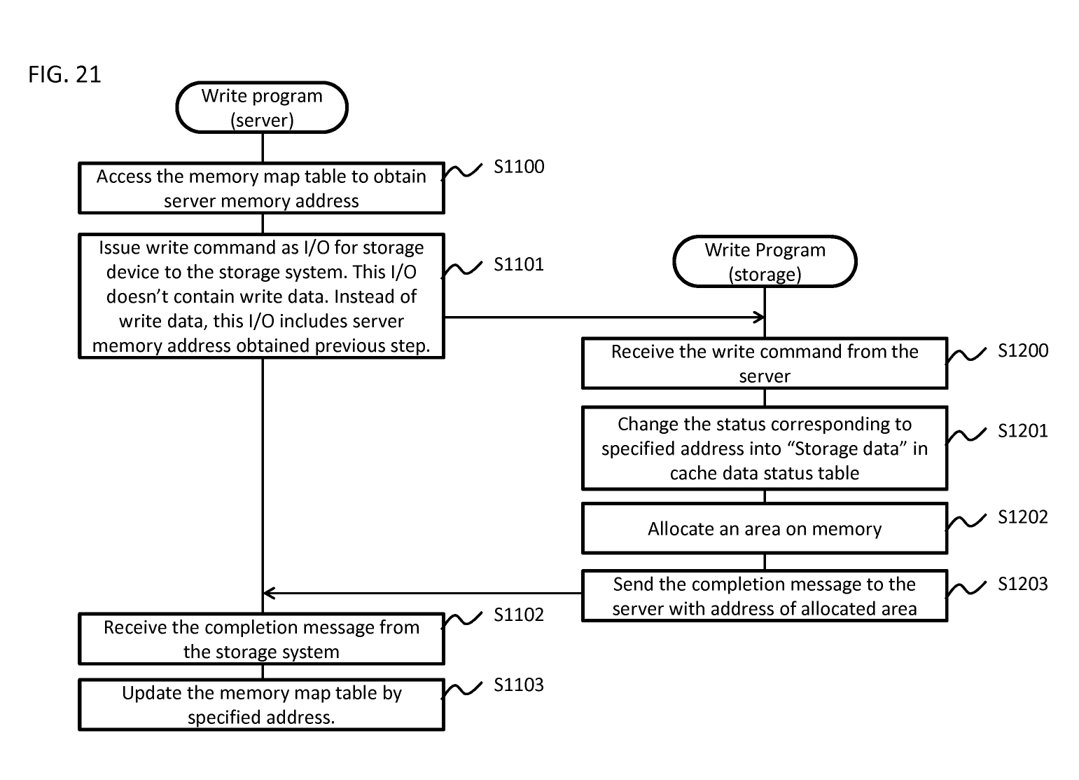

FIG. 21 is an example of a flow diagram illustrating a write processing flow according to the second embodiment. Steps S1100 and S1101 are the same as steps S400 and S401 of FIG. 10. The write program (storage) receives the write command and changes the status corresponding to the specified address into storage data in the cache data status table (step S1200). The write program (storage) allocates an area on the memory (step S1202) and sends a completion message to the server 100 with the address of the allocated area (step S1203). Since the memory 211 whose status is server data decreases (due to the change in status from “server data” to “storage data” in step S1201), the write program (storage) allocates another area of the memory 211 with status “server data.” The write program (server) receives the completion message from the storage system 200 and updates the memory map table 106 using the specified address (steps S1102 and S1103).

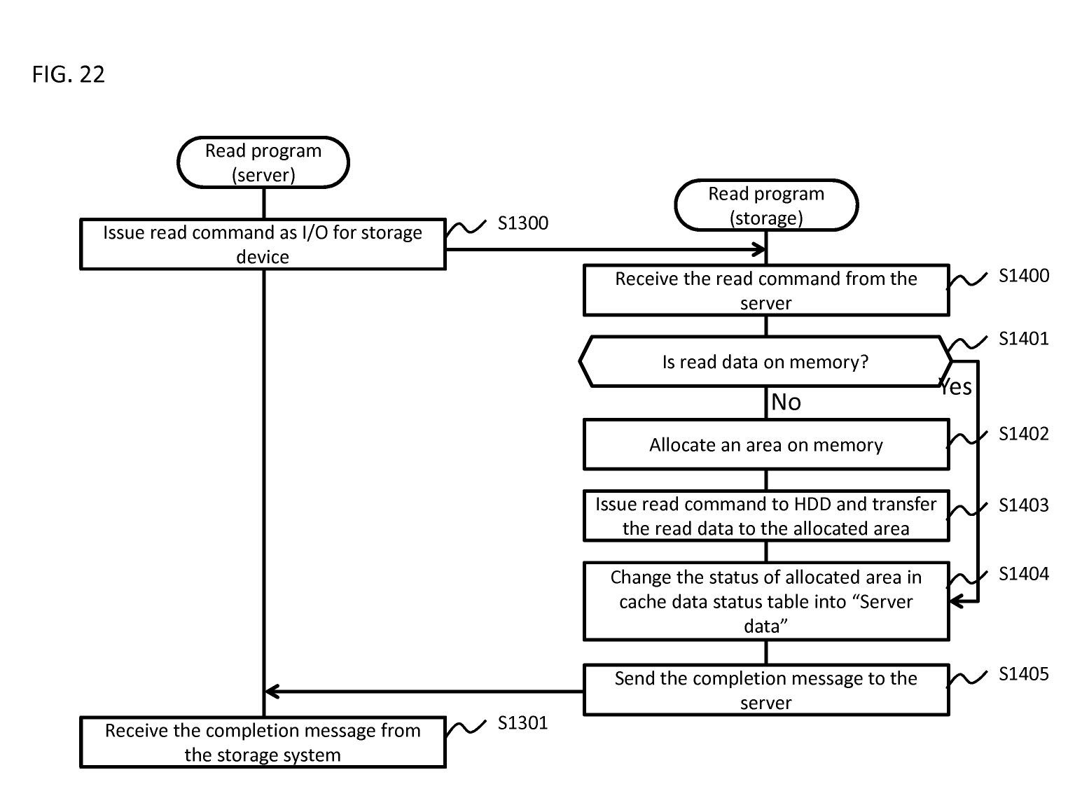

FIG. 22 is an example of a flow diagram illustrating a read processing flow according to the second embodiment. In step S1300, the read program (server) issues a read command as I/O for storage device to the storage system 200. Steps S1400 to S1403 are the same as steps S1000 to S1003 of FIG. 13. The read program (storage) changes the status corresponding to the allocated area into server data in the cache data status table (step S1404). Then, the read program (storage) sends a completion message to the server 100 (step S1405). Finally, the read program (server) receives the completion message from the storage system 200 (step S1301).

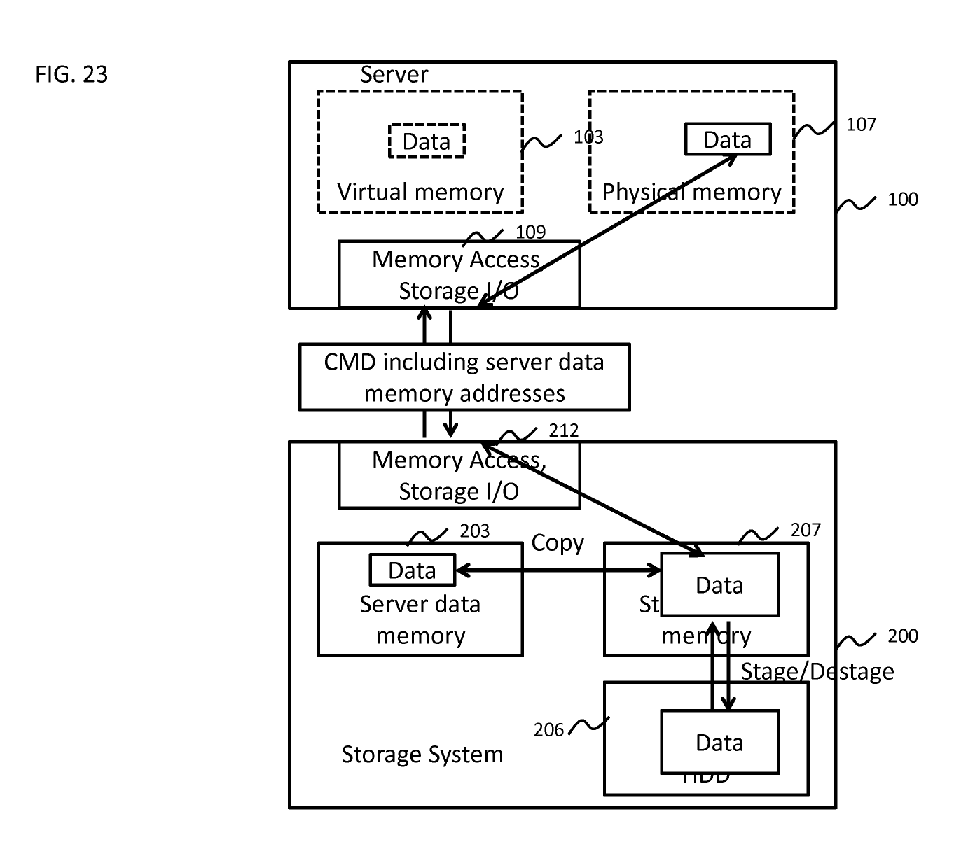

FIG. 23 is a conceptual diagram illustrating the sharing of physical I/F between the server 100 and storage system 200 by memory access processing and storage I/O processing. Commands as I/O for storage device and commands as I/O for server memory device are processed through the same physical I/F, namely, memory access, storage I/O 109 on the server 100 and memory access, storage I/O 212 on the storage system 200.

### Third Embodiment

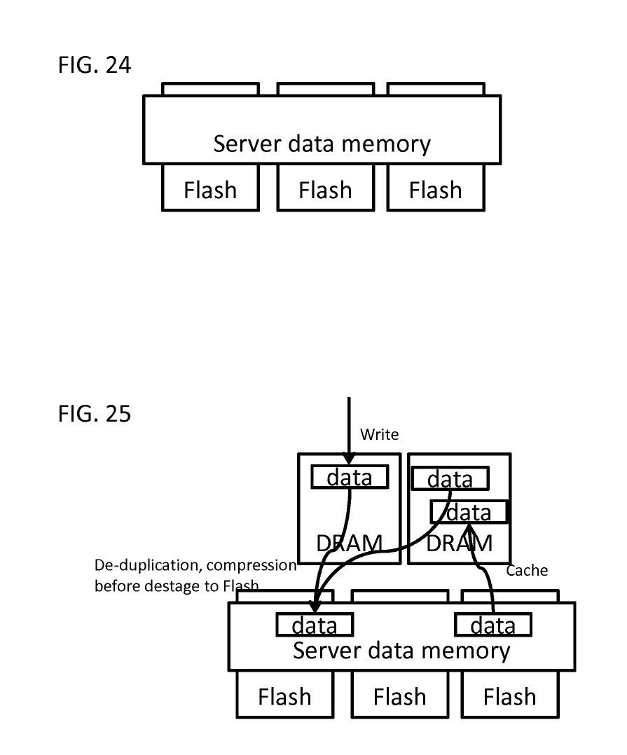

For cost reduction, the server data memory 203 is configured logically on Flash Memories. FIG. 24 shows this configuration. Access latency of the configuration is larger than DRAM. Further, the configuration affects Flash Memory endurance. The third embodiment solves the above problems by using DRAMs and Flash Memories. The server data memory 203 is configured logically on Flash Memories. DRAMs are used as a cache media of Flash Memories. The storage system 200 executes destaging of the server memory data from DRAMs to Flash Memories after de-duplication and/or compression of them, as illustrated in FIG. 25.

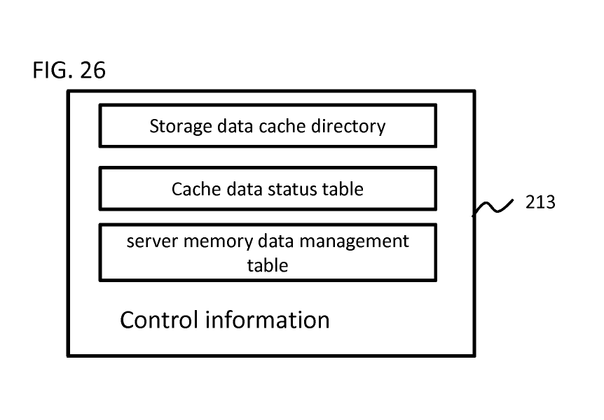

FIG. 26 is a detailed block diagram showing the control information unit 213 in accordance with the third embodiment. In addition to the storage data cache directory and the cache data status table of the second embodiment (FIG. 19), a server memory data management table is provided to manage the storing medium and address of the data and hash value.

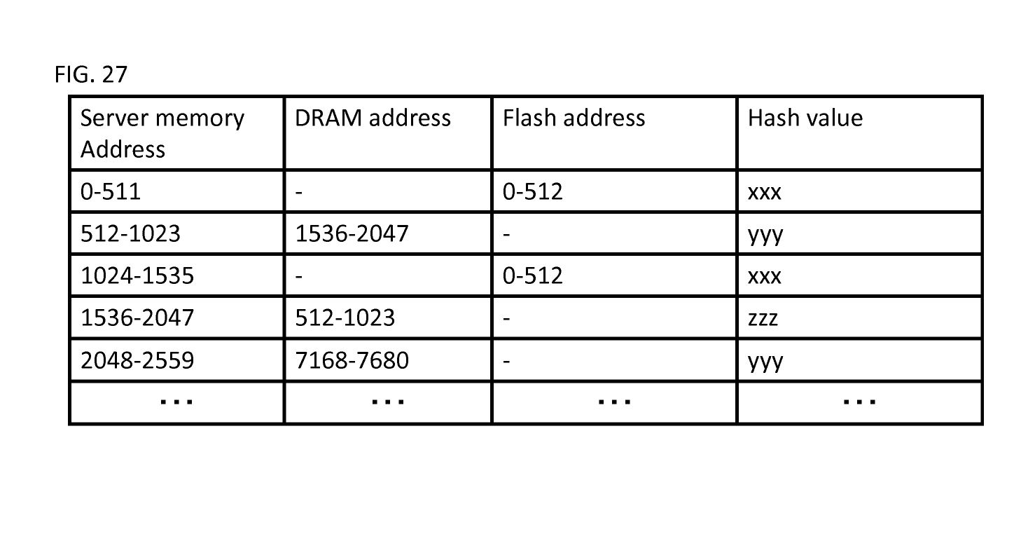

FIG. 27 shows an example of a server memory data management table. Data of server addresses 0-512 and 1024-1535 are stored in same address (0-512) on Flash Memory. Data of server address 1536-2047 has been stored in DRAM, not in Flash Memory. Data of server address 512-1023 and data of server address 2048-2559 are the same (same hash value). Thus, these two data will be de-duplicated and stored in the same address on Flash Memory.

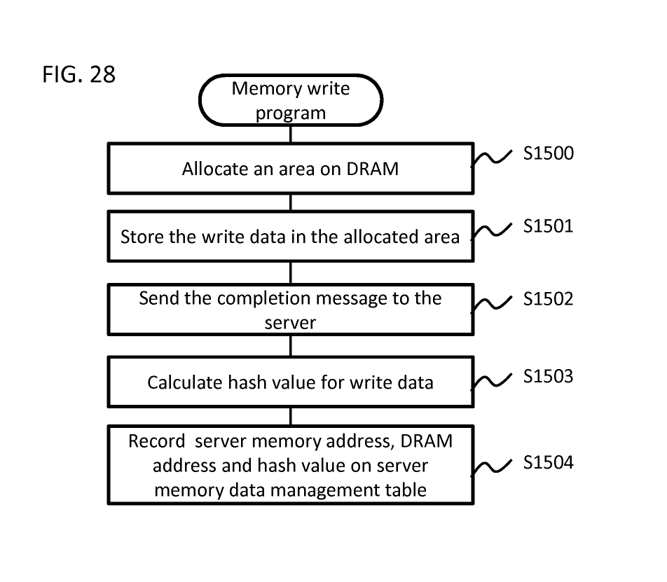

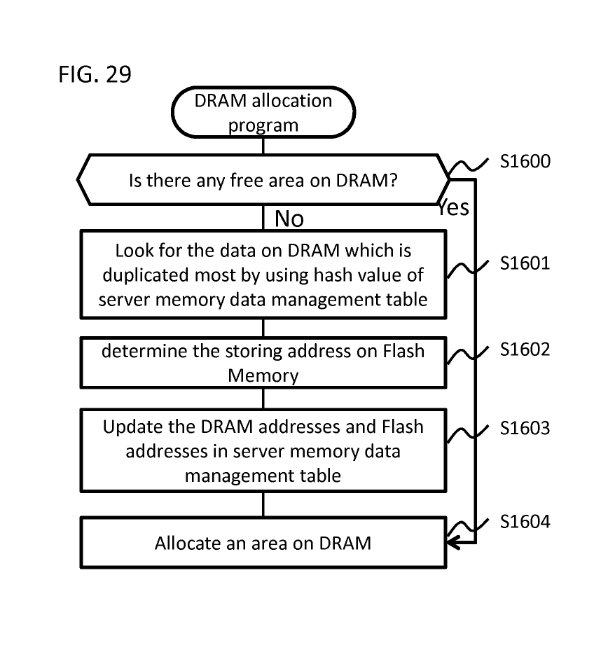

FIG. 28 is an example of a flow diagram illustrating a processing flow of memory write according to the third embodiment. In step S1500, the memory write program receives a memory write request from the server 100 and allocates an area on DRAM. This step calls a DRAM allocation program described below in connection with FIG. 29. After allocation, the memory write program stores the server memory data in the allocated area (step S1501) and sends a completion message to the server 100 (step S1502). Finally, the memory write program calculates a hash value for the written server memory data (step S1503) and records the server memory address, DRAM address, and hash value on the server memory data management table (step S1504).

FIG. 29 is an example of a flow diagram illustrating a processing flow of a DRAM allocation program called from the memory write program in FIG. 28. In step S1600, the DRAM allocation program confirms whether there is any free area on DRAM. If there is free area on DRAM, the DRAM allocation program proceeds to step S1604. If there is no free area on DRAM, the DRAM allocation program performs steps S1601 to S1603 before step S1604. In step S1601, the DRAM allocation program looks for the data on DRAM which is duplicated most by using the hash value of the server memory data management table. In step S1602, the DRAM allocation program determines the server data storing address on Flash Memory. This address is chosen from addresses of Flash Memory corresponding to duplicated server memory data. In step S1603, the DRAM allocation program updates the DRAM addresses and Flash addresses corresponding to duplicated server memory data on server memory data management table. Finally, the DRAM allocation program allocates an area on DRAM (step S1604). In the method of FIG. 29, de-duplication and/or compression of the data on DRAM and writing reduced data to the Flash Memory is executed after DRAM fills. De-duplication and/or compression could be executed to timing other than the above.

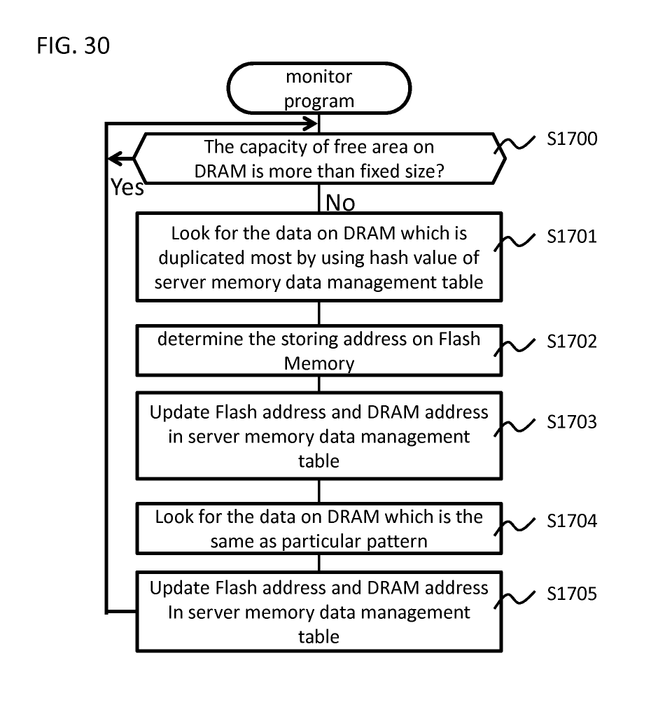

FIG. 30 is an example of a flow diagram illustrating a processing flow of a monitor program executing de-duplication and/or compression according to the amount of free space of DRAM. In step S1700, the monitor program confirms whether the capacity of free area on DRAM is more than a preset fixed size. If yes, the monitor program skips steps S1701 to S1704 and proceeds to step S1705. If no, the monitor program performs steps S1701 to S1704 before step S1705. In steps S1701 to S1703, de-duplication and/or compression is executed. These steps are the same as steps S1601 to S1603 in FIG. 29. Another method to reduce the data may be considered. The particular patterned data such as all zero is beforehand stored on the Flash Memory. Further, address of the data which is the same as a particular patterned data is changed into the address storing the particular patterned data. To achieve the above data reduction, the monitor program looks for the data on DRAM which is the same as the particular patterned data (step S1704). Then, monitor program updates the Flash address and DRAM address in the server memory data management table. The flash address is changed into the address storing the particular patterned data. The DRAM address is changed into the value “−.”

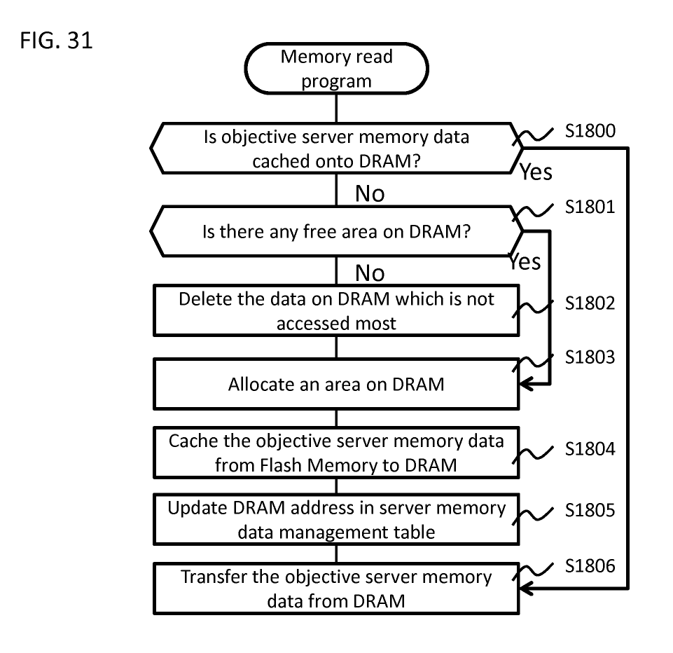

FIG. 31 is an example of a flow diagram illustrating a processing flow of a memory read program in order to cache the data from Flash Memory to DRAM according to the third embodiment. With this program, the latency of server memory access could be improved. In step S1800, the memory read program confirms whether the object server memory data is already cached. If the object server memory data is cached, the memory read program skips steps S1801 to S1805 and proceeds to step S1806. If the object server memory data is not cached, the memory read program performs steps S1801 to S1805. In step S1801, the memory read program confirms whether there is any free area on DRAM. If there is no free area on DRAM, the memory read program deletes the data on DRAM which is not accessed the most (step S1802). If there is free area on DRAM, the memory read program skips step S1802 and proceeds to step S1803. In step S1803, the memory read program allocates an area on DRAM. Then, the monitor program caches the object server memory data from Flash Memory to DRAM (step S1804). The address on Flash Memory storing the object server memory data could be determined by using the server memory data management table. In step S1805, the monitor program updates the DRAM address in the server memory data management table. Finally, the monitor program transfers the object server memory data from DRAM to the server (step S1806).

Of course, the system configuration illustrated in FIG. 1 is purely exemplary of information systems in which the present invention may be implemented, and the invention is not limited to a particular hardware configuration. The computers and storage systems implementing the invention can also have known I/O devices (e.g., CD and DVD drives, floppy disk drives, hard drives, etc.) which can store and read the modules, programs and data structures used to implement the above-described invention. These modules, programs and data structures can be encoded on such computer-readable media. For example, the data structures of the invention can be stored on computer-readable media independently of one or more computer-readable media on which reside the programs used in the invention. The components of the system can be interconnected by any form or medium of digital data communication, e.g., a communication network. Examples of communication networks include local area networks, wide area networks, e.g., the Internet, wireless networks, storage area networks, and the like.

In the description, numerous details are set forth for purposes of explanation in order to provide a thorough understanding of the present invention. However, it will be apparent to one skilled in the art that not all of these specific details are required in order to practice the present invention. It is also noted that the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged.

As is known in the art, the operations described above can be performed by hardware, software, or some combination of software and hardware. Various aspects of embodiments of the invention may be implemented using circuits and logic devices (hardware), while other aspects may be implemented using instructions stored on a machine-readable medium (software), which if executed by a processor, would cause the processor to perform a method to carry out embodiments of the invention. Furthermore, some embodiments of the invention may be performed solely in hardware, whereas other embodiments may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

From the foregoing, it will be apparent that the invention provides methods, apparatuses and programs stored on computer readable media for efficient I/O processing in storage system. Additionally, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the terms used in the following claims should not be construed to limit the invention to the specific embodiments disclosed in the specification. Rather, the scope of the invention is to be determined entirely by the following claims, which are to be construed in accordance with the established doctrines of claim interpretation, along with the full range of equivalents to which such claims are entitled.

What is claimed is:

1. A storage system comprising:
a memory; and
a controller being operable to execute a process for data stored in the memory so that an address of the data stored in the memory is changed between a first address managed in a virtual memory on a server and a second address managed by the controller, based on a command containing an address corresponding to the first address, the command being sent from the server to the storage system.

2. The storage system according to claim 1,
wherein the memory includes a server data memory and a storage data memory;
wherein if the command is a write command including an address in the server data memory, the controller is configured to copy data from the address in the server data memory to the storage data memory; and
wherein if the command is a read command including an address in the server data memory, the controller is configured to copy data from the storage data memory to the address in the server data memory.

3. The storage system according to claim 1, further comprising:
a first type interface being operable to communicate with the server using a memory access; and
a second type interface being operable to communicate with the server using a storage I/O (Input/Output) access.

4. The storage system according to claim 3,
wherein the controller is operable to manage data as either data to be communicated via the first type interface or data to be communicated via the second type interface.

5. The storage system according to claim 1, wherein the memory includes a server data memory and a storage data memory, and wherein in response to a write command containing a specified address from the server, the controller is operable to:
allocate an area in the storage data memory; and
copy write data from the server data memory, at the specified address contained in the write command, to the allocated area of the storage data memory.

6. The storage system according to claim 1, wherein the memory includes a server data memory and a storage data memory, and wherein in response to a read command containing a specified address from the server, the controller is operable to:
if read data is stored in the storage data memory, transfer the read data from the storage data memory to the server data memory, at the specified address contained in the read command; and
if read data is not stored in the storage data memory, allocate an area in the storage data memory, transfer the read data from a storage device in the storage system to the allocated area in the storage data memory, and transfer the read data from the allocated area in the storage data memory to the server data memory, at the specified address contained in the read command.

7. The storage system according to claim 1, wherein the memory includes a server data memory and a storage data memory, and wherein in response to a read command containing a specified address from the server, the controller is operable to:
if there is dirty data, allocate an area in the storage data memory, transfer the read data from a storage device in the storage system to the allocated area in the storage data memory to be merged with the dirty data, and transfer the read data from the allocated area in the storage data memory to the server data memory, at the specified address contained in the read command; and
if there is no dirty data, transfer the read data from a storage device in the storage system to the server data memory, at the specified address contained in the read command.

8. The storage system according to claim 1,
wherein in response to the command from the server, the controller is operable to change a status of data stored in the memory from server data to storage data or from storage data to server data.

9. The storage system according to claim 1, wherein the memory includes DRAM and Flash memory, and wherein the controller is operable to:
configure server data memory logically on the Flash memory for storing server memory data;
use the DRAM as a cache media of the Flash memory; and
execute destaging of the server memory data stored in the server data memory configured on the Flash memory after at least one of de-duplication or compression of the server memory data.

10. The storage system according to claim 1, further comprising:
an interface being operable to communicate with the server for both memory access processing and storage I/O (Input/Output) processing.

11. A computer-readable storage medium storing a plurality of instructions for controlling a data processor to manage data in a storage system having a memory and a controller, the plurality of instructions comprising:
instructions that cause the data processor to execute a process for data stored in the memory so that an address of the data stored in the memory of the storage system is changed between a first address managed in a virtual memory on a server and a second address managed by the controller, based on a command containing an address corresponding to the first address, the command being sent from the server to the storage system.

12. The computer-readable storage medium according to claim 11, wherein the memory includes a server data memory and a storage data memory, and wherein the plurality of instructions further comprise:
if the command is a write command including an address in the server data memory, instructions that cause the data processor to copy data from the address in the server data memory to the storage data memory; and
if the command is a read command including an address in the server data memory, instructions that cause the data processor to copy data from the storage data memory to the address in the server data memory.

13. The computer-readable storage medium according to claim 11, wherein the storage system includes a first type interface being operable to communicate with the server using a memory access and a second type interface being operable to communicate with the server using a storage I/O (Input/Output) access, and wherein the plurality of instructions further comprise:
instructions that cause the data processor to manage data as either data to be communicated via the first type interface or data to be communicated via the second type interface.

14. The computer-readable storage medium according to claim 11, wherein the memory includes a server data memory and a storage data memory, and wherein the plurality of instructions further comprise:
in response to a write command containing a specified address from the server, instructions that cause the data processor to allocate an area in the storage data memory, and to copy write data from the server data memory, at the specified address contained in the write command, to the allocated area of the storage data memory; and
in response to a read command containing a specified address from the server, instructions that cause the data processor to
if read data is stored in the storage data memory, transfer the read data from the storage data memory to the server data memory, at the specified address contained in the read command; and
if read data is not stored in the storage data memory, allocate an area in the storage data memory, transfer the read data from a storage device in the storage system to the allocated area in the storage data memory, and transfer the read data from the allocated area in the storage data memory to the server data memory, at the specified address contained in the read command.

15. The computer-readable storage medium according to claim 11, wherein the memory includes a server data memory and a storage data memory, and wherein the plurality of instructions further comprise, in response to a read command containing a specified address from the server:
if there is dirty data, instructions that cause the data processor to allocate an area in the storage data memory, transfer the read data from a storage device in the storage system to the allocated area in the storage data memory to be merged with the dirty data, and transfer the read data from the allocated area in the storage data memory to the server data memory, at the specified address contained in the read command; and
if there is no dirty data, instructions that cause the data processor to transfer the read data from a storage device in the storage system to the server data memory, at the specified address contained in the read command.

16. The computer-readable storage medium according to claim 11, wherein the plurality of instructions further comprise:
in response to the command from the server, instructions that cause the data processor to change a status of data stored in the memory from server data to storage data or from storage data to server data.

17. A method of managing data in a storage system having a memory and a controller, the method comprising:
executing a process for data stored in the memory so that an address of the data stored in the memory is changed between a first address managed in a virtual memory on a server and a second address managed by the controller, based on a command containing an address corresponding to the first address, the command being sent from the server to the storage system.

18. The method according to claim 17, wherein the memory includes a server data memory and a storage data memory, and the method further comprises:
if the command is a write command including an address in the server data memory, copying data from the address in the server data memory to the storage data memory; and
if the command is a read command including an address in the server data memory, copying data from the storage data memory to the address in the server data memory.

19. The method according to claim 17, wherein the memory includes a server data memory and a storage data memory, and the method further comprises:
in response to a write command containing a specified address from the server, allocating an area in the storage data memory; and copying write data from the server data memory, at the specified address contained in the write command, to the allocated area of the storage data memory; and
in response to a read command containing a specified address from the server,
if read data is stored in the storage data memory, transferring the read data from the storage data memory to the server data memory, at the specified address contained in the read command; and
if read data is not stored in the storage data memory, allocating an area in the storage data memory, transferring the read data from a storage device in the storage system to the allocated area in the storage data memory, and transferring the read data from the allocated area in the storage data memory to the server data memory, at the specified address contained in the read command.

20. The method according to claim 17, further comprising:
in response to the command from the server, changing a status of data stored in the memory from server data to storage data or from storage data to server data.
